(19) United States
(12) Patent Application Publication
(10) Pub. No.: US 2023/0145714 A1
(43) Pub. Date: May 11, 2023

(54) APPARATUS AND METHOD FOR A PHONATION SYSTEM

(71) Applicant: Emily Cadiz, Hillsboro, OR (US)

(72) Inventor: Emily Cadiz, Hillsboro, OR (US)

(21) Appl. No.: 17/982,245

(22) Filed: Nov. 7, 2022

Related U.S. Application Data
(60) Provisional application No. 63/276,993, filed on Nov. 8, 2021.

(51) Int. Cl. G10L 25/51; G10H 1/36

(52) U.S. Cl. CPC G10L 25/51; G10H 1/365

(57) ABSTRACT

A system and method for presenting a phonation system game that includes a graphical animation and a phonation system song to a child using an electronic screen-based device is provided. One embodiment detects sounds of the singing child; identifies a song word sung by the child; identifies a song word presented by the phonation system song, wherein the song word presented by the phonation system is the same as the song word sung by the child; identifies an attribute of interest in the song word sung by the child; retrieves a predefined song word attribute associated with the song word presented by the phonation system from a coded event database, wherein the predefined song word attribute is associated with the song word sung by the child; and compares the predefined song word attribute with the identified attribute of interest in the song word sung by the child.

### PRIORITY CLAIM

This application claims priority to copending U.S. Provisional Application, Serial No. 63276993, filed on Nov. 8, 2021, entitled Apparatus and Method For A Phonation System, which is hereby incorporated by reference in its entirety for all purposes.

### BACKGROUND OF THE INVENTION

Inclusive music programs are intended to provide learning environments where students both with and without disabilities participate successfully and happily in meaningful music experiences. In particular, there is increasing interest in typical and atypical language and literacy acquisition of pre-school age children. Systems for testing and measuring a child’s acquisition of language and literacy are problematic at best in determining a pre-school age child’s progress in their language and/or early literacy acquisition. And, such testing and measuring systems can be deficient in measuring progress of the child over time.

Further, pre-school age children that are diagnosed as being atypical and/or with disabilities often have difficulties in keeping up with other same-age students, particularly if their performance is based on standardized performance levels that are applicable to neuro-typical children and/or to children without disabilities.

By the time pre-school age children have entered a traditional kindergarten through twelve grade (K-12) classroom, many are still working to master basic sounds for a variety of reasons including developmental barriers, socio-economic status, English as a second language, and/or regional vernaculars. Further, such children may not yet be literate. In addition, speech and language disorders, articulation issues, auditory processing disorders and/or Autism are often undiagnosed until later elementary school, putting many children at a disadvantage when faced with a subject that primarily focuses on phonation.

Further, if a particular pre-school age child is not acquiring language and/or literacy skills at an acceptable rate, detection and identification of the pre-school age child’s deficiency is very difficult. If a pre-school age child’s delayed development in their language and/or early literacy acquisition skills could be detected and identified, then speech and/or language intervention may be taken to help the pre-school age child’s development.

Accordingly, in the arts of phonation, particularly for young pre-school age children, there is a need in the arts for improved screening methods, apparatus, and systems for facilitating language and early literacy acquisition and development.

### SUMMARY OF THE INVENTION

Embodiments of the phonation system provide a system and method for A system and method for presenting a phonation system game that includes a graphical animation and a phonation system song to a child using an electronic screen-based device. One embodiment detects sounds of the singing child; identifies a song word sung by the child; identifies a song word presented by the phonation system song, wherein the song word presented by the phonation system is the same as the song word sung by the child; identifies an attribute of interest in the song word sung by the child; retrieves a predefined song word attribute associated with the song word presented by the phonation system from a coded event database, wherein the predefined song word attribute is associated with the song word sung by the child; and compares the predefined song word attribute with the identified attribute of interest in the song word sung by the child.

### BRIEF DESCRIPTION OF THE DRAWINGS

The components in the drawings are not necessarily to scale relative to each other. Like reference numerals designate corresponding parts throughout the several views.

FIG. 1 is a block diagram of an example phonation system implemented in an example electronic screen-based device.

FIG. 2 is a hypothetical conceptual diagram of a non-limiting electronic screen-based device that is presenting a phonation system game.

FIG. 3 is an example block diagram of a distributed computing system that may be used to practice embodiments of a phonation system described herein.

### DETAILED DESCRIPTION

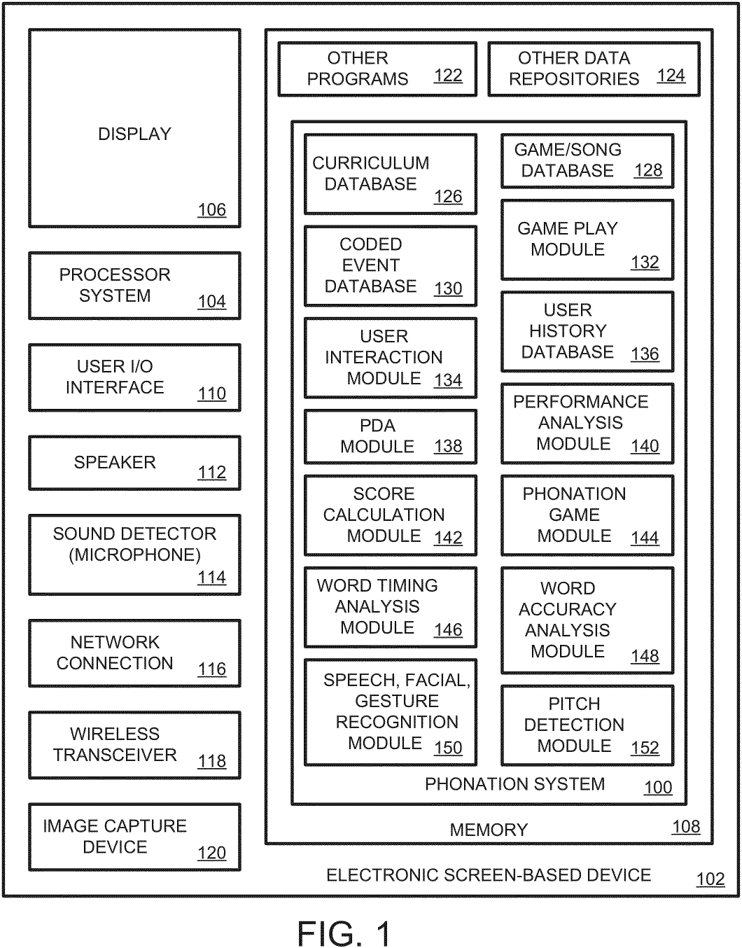

FIG. 1 is a block diagram of an example phonation system 100 implemented in an example electronic screen-based device 102. Embodiments of the phonation system 100 are predicated on the premise that neurological music therapy strategies may be used to monitor a pre-school age child’s acquisition of pitch, language and/or early literacy skills. The goal of a phonation system 100 is to (1) assess a current state of a pre-school age child’s acquisition of pitch, language and/or early literacy skills, (2) track changes (improvement) in the child’s acquisition of language and/or early literacy skills, (3) identify any specific deficiencies in the child’s pitch, language and/or early literacy skills, and (4) provide information that may be used to develop a suitable speech and/or language intervention program to address any identified deficiencies.

Also, and most importantly, embodiments of the phonation system 100 must be fun for the child. Embodiments of the phonation system 100 employ a gaming configuration to capture the pre-school age child’s interest so that the child enthusiastically engages with the phonation system 100. Further, embodiments of the phonation system 100 are configured to maintain the child’s interest and engagement over time. When the child engages with the phonation system 100 over time, the child’s development of language and/or early literacy skills can be monitored. More particularly, measurable changes over time will lead to the identification of specific deficiencies in the child’s cognitive auditory processing skills.

The disclosed systems and methods for embodiments of the phonation system 100 will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of examples for a phonation system 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components. “Secured to” means directly connected without intervening components.

“Communicatively coupled” means that an electronic device exchanges information with another electronic device, either wirelessly or with a wire based connector, whether directly or indirectly through a phonation system 100. “Controllably coupled” means that an electronic device controls operation of another electronic device.

“Pre-school age children” are generally defined to be children between the ages of two to five, though the inventors appreciate that every child is unique and individual, and may enjoy embodiments of the phonation system 100. A normally developed pre-school age child will have acquired various levels language skills (ability to communicate using verbal language), and likely some music skills (ability to perceive and create musical pitch and/or tones using their voice, and/or using an age-appropriate musical instrument). Generally, a pre-school age child has not yet acquired literacy skills (at least to a reading level of proficiency).

A graphical animation is the animation of one or more of a plurality of graphical objects presented on a display screen, wherein one of more selected objects are presented as moving images in the presenting video stream.

Further, pre-school age children are assumed to have a basic and functional understanding of electronic screen-based devices 102 so that they are able to intuitively understand images that are presented on a display screen of the electronic screen-based device 102, understand language and music emitted by speakers of the electronic screen-based device 102, and understand manipulation of various user interface devices to control the operation of the electronic screen-based device 102 (e.g., operation using a touch sensitive display screen). That is, a pre-school age child is able to consume visual and audio content presented from their electronic screen-based device 102, and to some extent, control operation of the presentation of the content on their electronic screen-based device 102. Such electronic screen-based devices 102 include, but are not limited to, a personal computer, a laptop computer, a tablet, a smartphone, a gaming device, a portable media player, a virtual reality headset, or the like.

“Phonation” refers to the process by which a person’s vocal cords produce certain sounds, such as speech. Produced sounds may be characterized by a harmonic series of vibrations that, when projected through the air from the person’s vocal cords, creates an audible sound that is detectable by a person’s ear or an electronic device. The sound comprises a fundamental frequency, interchangeably referred herein as “pitch”, and harmonic overtones that are multiples of the fundamental frequency. One skilled in the art understands the well-known process of phonation and the characterization of sound in terms of pitch and overtone harmonics. Accordingly, such knowledge is not disclosed herein for brevity, other than to the extent necessary for one skilled in the art to make, use and practice the various embodiments of the phonation system 100.

Returning to FIG. 1, the phonation system 100 is illustrated as residing in an example electronic screen-based device 102. The generic embodiment of the electronic screen-based device 102 comprises a processor system 104, a display 106, a memory 108, on or more user input and output (I/O) interfaces 110, a speaker 112, a sound detector 114, an optional network connection 116, an optional wireless transceiver 118, and an optional image capture device 120. In some embodiments, the display 106 is a touch sensitive display screen.

The memory 108 comprises portions for storing the phonation system 100, other programs 122 that may be executed by the electronic screen-based device 102, and other data repositories 124 that may be accessed as needed by the electronic screen-based device 102. The non-limiting example phonation system 100, residing in memory 108, comprises an optional curriculum database 126, a game and song database 128, a coded event database 130, a game play module 132, a user interaction module 134, a user history database 136, a pitch detection algorithm (PDA) module 138, a performance analysis module 140, a score calculation module 142, a phonation game module 144, a word timing analysis module 146, a word accuracy analysis module 148, an optional speech, face and gesture recognition module 150, and a pitch detection module 152. In some embodiments, the various modules (interchangeably referred to herein as engines) may be integrated together, and/or may be integrated with other logic. In other embodiments, some or all of these memory and other data manipulation functions may be provided by using a remote server or other electronic devices suitably connected via the Internet or otherwise to a client. Other electronic screen-based devices 102 and/or the phonation systems 100 may include some, or may omit some, of the above-described components. Further, additional components not described herein may be included in alternative embodiments.

An example embodiment of the phonation system 100 is illustrated as being implemented in an electronic screen-based device 102 that is operable by a pre-school age child. The pre-school age child may be interchangeably referred to herein as a “user” who is using the electronic screen-based device 102. As noted above, embodiments of the phonation system 100 employ a gaming configuration that presents a song-based game to the pre-school age child. The intent is to present a selected song (output from the speaker 112), with presentation of a corresponding graphical animation (presented on the display 106). The audible musical song and graphical animation are intended to capture the pre-school age child’s interest so that the child enthusiastically engages with the phonation system 100. Here, the intent is to prompt the child to sing along with the presenting audible music and graphical animation.

A suitable sound detector 114 is configured to detect the audible response of the pre-school age child who is preferably singing along with, or is attempting to sing along with, the presenting audible song and graphical animation. Any suitable audio detection device 114 now known or later developed may be used in the various embodiments. The sound detector 114 is configured to detect sounds with sufficient discrimination so that spoken words are determinable, and so that the pitch attributes of the pre-school age child’s singing voice is determinable.

Further, embodiments of the phonation system 100 are configured to maintain the pre-school age child’s interest and engagement over time. When the child engages with the phonation system 100 over time, the child’s development of pitch, language and/or early literacy skills can be monitored. More particularly, measurable changes over time will provide information that can lead to the identification of specific deficiencies in the child’s acquisition of language and/or early literacy skills.

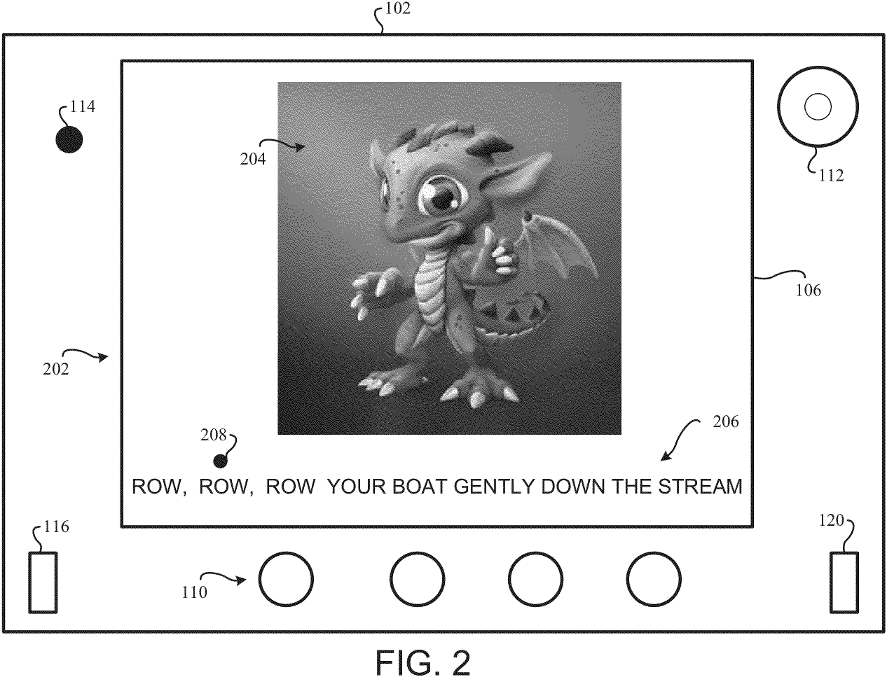

FIG. 2 is a hypothetical conceptual diagram of a non-limiting electronic screen-based device 102 that is presenting a phonation system game. The pre-school age child using their electronic screen-based device 102 views a graphical animation 202 of a character 204 that is preferably animated in a manner that shows the character singing a phonation system song. Here, the character 204 is illustrated as a friendly dragon that is configured to capture and maintain the attention of the pre-school age child. Other animated characters may be used in the various embodiments. The graphical animation 202 may further include a background scene and/or other animated characters (not shown) to improve the aesthetics of the graphical animation 202, and in particular, to increase and maintain the pre-school age child’s engagement with the presenting phonation system game. Here, the graphical animation 202 and the phonation system song are synchronously presented together to the child by the electronic device 102.

At times, the pre-school age child may be supervised by an adult, such as a parent, a teacher, or a medical profession practitioner. For example, the parent and/or teacher may be helping the pre-school age child learn a particular phonation system song that is being currently presented by the phonation system 100.

FIG. 2 presents optional song text 206 on the display 106. The song text helps the adult understand and verbalize the presenting phonation system song, preferably in a manner that prompts the pre-school age child to sing along with the presenting phonation system song that is being presented from the speaker 112 (as an audible song).

One skilled in the art appreciates that the viewing pre-school age child is unable to read and comprehend the presenting song text 206. However, embodiments preferably present a song text visible queue 208 that indicates currently presenting song words, such as the example song word “ROW” that is conceptually illustrated in FIG. 2. In this simplified example, the queue 208 is conceptually illustrated as a dot or other suitable graphical icon that is understood to move along in proximity to each currently presenting word in the presenting song text 206. That is, the queue 208 is presented in synchronism with presentation of the current words of the phonation system song. Alternatively, or additionally, highlighting of the currently presenting song word and/or a field region around the current song word may be used to visually indicate the currently presenting song word. Accordingly, the adult will appreciate the presentation timing of the song words, and will appreciate the particular currently presenting words of the phonation system song. That is, the presenting song text 206 and queue 208 enable the adult to sing along with the presenting phonation system song.

An unexpected benefit of presenting the song text 206 and queue 208 is that the viewing pre-school age child also gains an intuitive understanding of the presentation timing of the song words. As the pre-school age child repeatedly hears the phonation system song, and views the queue 208 that indicates the current song word, they will learn the song words, learn the timing of the song words, and learn the musical characteristics, interchangeably referred to as attributes, of the song. That is, as the pre-school age child learns to sing along with the presenting phonation system song, the presentation of the song text 206 and queue 208 facilitate the pre-school age child’s intuitive understanding of the timing of the song words as they are being presented during the phonation system song.

One skilled in the art appreciates that the electronic screen-based device 102 can be operated, at least to some extent, by the pre-school age child. Accordingly, the child is, at some point in their growth and development, able to manipulate the I/O devices 110 on the surface of the electronic screen-based device 102 to control presentation of the phonation system game and the associated phonation system songs. Accordingly, the pre-school age child may play the phonation system game without adult supervision.

In a preferred embodiment, the display 106 is a touch sensitive type display. In such embodiments, the child may touch predefined areas of the graphical animation 202 that is being presented on the display 106 that intuitively correspond to control characteristics of the phonation system game. One skilled in the art appreciates the aspects of controlling presentation of graphically-based games to young, pre-school age children. For brevity, systems and methods of describing computer games suitable for use by a pre-school age child are not described in detail herein other than as is necessary for explanation of the operation of embodiments of the phonation system 100.

An important novel feature provided by embodiments of the phonation system 100 is that selection of particular phonation system songs, and their associated phonation system game, is curriculum based. In the various embodiments, the phonation system 100 facilitates language and/or early literacy acquisition by a child using one or more predefined curriculum. Each curriculum is associated with one or more of the phonation system games, and each of the phonation system games are associated with particular phonation system songs. The curriculums and associated information may be stored in the curriculum database 126. Embodiments may be configured to present information on the display 106 that describes a particular curriculum.

In response to specification of a particular curriculum, the phonation system 100 selects a particular phonation system game and phonation system songs that support target objectives of a particular curriculum of interest. Namely, the various curriculums support developmentally appropriate language and early literacy acquisition objects for the developing pre-school age child. For example, if the adult intends that the operating phonation system 100 is to facilitate acquisition of a particular annunciation skill by the pre-school age child, then the adult may specify a particular curriculum associated with the skill of interest to the phonation system 100.

As conceptually illustrated in FIG. 2, the presenting phonation system song is the well-known “Row, Row, Row Your Boat” song that is often taught to children of all ages. The associated hypothetical curriculum is associated with development of annunciation skills with words having an “R” sound. In this hypothetical example, the phonation system song “Row, Row, Row Your Boat” is a phonation system song that has been associated with the above-described curriculum. In a preferred embodiment, a plurality of different curriculums are stored in the curriculum database 126. Each curriculum is associated with one or more phonation system games. When a particular curriculum is designated by the adult, the phonation system 100 retrieves the associated phonation system game from the game and song database 128 when the child is playing a phonation system game. As the selected phonation system game associated with a specified curriculum is being presented, under the management and the control of the game play module 132, the retrieved phonation system songs and animations 204 associated with the designated curriculum are presented to the pre-school age child.

During presentation of the phonation system song and the corresponding graphical animation 202 generated and rendered by the phonation game module 144, the sound detector 114 detects sound in proximity to the electronic screen-based device 102. Here, detected sounds include the presenting phonation system song, and hopefully, the voice of the pre-school age child who is singing along with the presenting phonation system song. Any suitable sound detector device 114, such as a microphone or the like, may be employed by the various embodiments. The sound detector 114 outputs an audio data stream corresponding to the detected sounds. The output audio data stream, which may be in the form of analog information or digital information, is communicated to the processor system 104 that is executing the various modules of the phonation system 100.

In an example embodiment, the user interaction module 134 processes the information in the detected audio stream to parse out the phonation system song (emitted from the speaker 112), the child’s singing voice, and other detected background noises. The parsed out portion of the audio stream corresponding to the child’s singing voice is then processed by the various modules of the phonation system 100. Each song word that is sung by the child is then identified within the corresponding parsed out portion of the detected audio stream. That is, the phonation system 100 identifies a song word sung by the child from the parsed output stream of audio data. Similarly, each song word that is presented by the parsed out phonation system song is then identified within the corresponding parsed out portion of the detected audio stream. Various attributes associated with each song word that has been sung by the child may then be analyzed by embodiments of the phonation system 100.

For each song word of the phonation system song, each song word has one or more predefined attributes. Information defining these various predefined song word attributes are stored into the coded event database 130. Here, presentation of a song word is referred to herein as an event. The associated attribute information is referred to as coded event information for that specific song word in the presented phonation system song.

A first example attribute for a song word, saved as coded event information, identifies the song word’s location, time, and/or duration of presentation during the phonation system song. Within the phonation system song, the song word may be time stamped and/or location identified. In some embodiments, the location and/or time of the start of the song word and the end of the song word may be identified. For example, a time duration for singing any particular song word may be specific depending upon the song itself. For example, the song word “row” may be associated with a predefined duration and time of occurrence in the phonation system song “Row, Row, Row Your Boat.” One skilled in the art appreciates that the duration of the song word “row” is likely different from a duration of the same word when spoken during a normal conversation between two or more people. Once the location, time, and/or duration attributes of a particular song word are determined based on analysis of the phonation system song, this determined information is stored as coded event information in the coded event database 130.

One skilled in the art appreciates that to properly learn and sing a song, the pre-school age child must learn each song word of the song, and also learn when and for how long to sing each particular song word. Embodiments of the phonation system 100, executing the word timing analysis module 146, retrieves associated timing attributes for each song word from the coded event database 130, and then compares the corresponding identified attributes of the song word as sung by the child during presentation of the phonation system song. Here, the comparison of the predefined song word attribute with the identified attribute of interest in the song word sung by the child corresponds to accuracy of the child’s ability to accurately sing the song word. If the timing attributes determined from the detected song word as sung by the child correspond with the predefined timing attributes of that song word, then the performance analysis module 140 determines that the child has accurately sung that particular word at the appropriate time, and for the appropriate duration, when they sang the phonation system song. If there are differences between the location, time, and/or duration attributes of the word as sung by the child and the predefined location, time, and/or duration attributes, the differences may be determined by the performance analysis module 140. Information corresponding to the analysis results is then saved into the user history database 136.

For example, an embodiment may determine a starting time of the song word sung by the child, and determine an ending time of the song word sung by the child. Then, the embodiment may compare a predefined starting time of the song word presented by the phonation system with the determined starting time of the song word sung by the child, and compare a predefined ending time of the song word presented by the phonation system with the determined ending time of the song word sung by the child. The embodiment may determine that the timing by the child is correct in response to determining that the starting time of the song word sung by the child is the same as the predefined starting time of the song word presented by the phonation system, and in response to determining that the ending time of the song word sung by the child is the same as the predefined ending time of the song word presented by the phonation system. Optionally, the embodiment may determine a first difference between the starting time of the song word sung by the child with the predefined starting time of the song word, and may determine a second difference between the ending time of the song word sung by the child with the predefined ending time of the song word. Then, the embodiment may determine that the timing by the child is correct when the first difference is within a first predefined threshold and/or the second difference is within a second predefined threshold. For example, the predefined threshold may be one or several milliseconds. This information may be saved for later comparisons to determine the child’s improvement in timing.

Another song word attribute is annunciation of the song word by the pre-school age child. That is, is the child properly annunciating the song word? As noted herein, the user interaction module 134 has parsed out the audio stream of the singing child. For each song word, the speech, face and gesture recognition module 150 determines annunciation attributes for the song word as sung by the child. The speech, face and gesture recognition module 150 retrieves predefined annunciation attributes from the coded event database 130 for each song word that is being sung by the child during presentation of the phonation system song. The speech, face and gesture recognition module 150 then compares the predefined annunciation attributes for a particular song word with the determined annunciation attributes of the sung song word. Here, the speech, face and gesture recognition module 150 may determine whether the child has properly annunciated the song word while singing. Any differences between the predefined annunciation attributes and the annunciation attributes of the song word as sung by the child can be identified. The speech, face and gesture recognition module 150 stores this annunciation information into the user history database 136.

Another song word attribute is the pitch of a particular song word when sung by the child during presentation of the phonation system song. Each song word of the phonation system song has a predefined pitch associated with that song word. Pitch attribute information associated with each song word is predefined based on a prior analysis of the phonation system song, and is saved into the coded event database 130. For each sung word, the pitch detection module 152 determines the sound frequencies (corresponding to the pitch) associated with each song word that is sung by the singing child.

The pitch detection algorithm (PDA) module 138 analyzes pitch characteristics (the determined sound frequencies) of the song word that has been sung by the child. The PDA module 138 is an algorithm that is designed to estimate the pitch (the fundamental frequency) and other frequencies of a quasiperiodic or oscillating signal, preferably using a digital form of the audio stream portion corresponding to the child’s singing voice. Any suitable PDA module 138 now known or later developed is intended to be within the scope of this disclosure and to be protected by the accompanying claims. The analysis performed by the PDA module 138 can be done in the time domain, the frequency domain, or both as is appreciated by one skilled in the art. For brevity, a detailed description of the theory and operation of pitch determination algorithms is not provided in detail herein other than to the extent necessary to understand operation of the phonation system 100.

For example, the pitch detection module 152 detects the pitch frequency of the sounds detected by the sound detector 114. The detected pitch input may be determined as a coded pitch range for each note of the phonation system song (e.g., 440hz for A4). The pitch frequency value, and the associated frequency range, for each song word in each of the phonation system song’s lyrics file has been predefined and saved as pitch attribute information in the coded event database 130.

The pitch attributes determined for each song word as sung by the child are compared with a predefined frequency range for the predefined pitch that has been associated with that song word by the PDA module 138. The comparison of the predefined song word attribute with the identified attribute of interest in the song word sung by the child corresponds to accuracy of the child’s ability to accurately sing the song word. The pitch of the song word as sung by the child may be determined to be correct by the PDA module 138 if the determined pitch of that song word falls within the predefined pitch frequency range for that particular song word. The PDA module 138 may determine that the voice pitch of the child is correct if the child’s pitch has the exact same pitch frequency (e.g., 440 hertz (hz) for A4), or any of its octaves (e.g., 440/2 for A3 or 440^{∗}2 for A5), or if the child’s pitch is within some predefined tolerance of the predefined pitch attributes (e.g., 25% of any octave). In this simplified illustrative example where the predefined pitch is 220 hz and the predefined tolerance range is 25%, then the child’s pitch would be deemed correct if the measured pitch of the child’s singing of the song word is between 180 hz and 260hz, and/or if an octave is within 360 hz to 520 hz. If the child’s pitch is incorrect (lies outside of the predefined pitch ranges), then the deviation for the predefined pitch frequency range is determined. Information corresponding to the determined pitch attributes for the child are saved into the user history database 136.

The various characteristics (attributes of a song word) used for assessing sounds for word measurements may be based on age appropriate consonants and vowels as defined in the well-known Goldman-Fristoe scale of language development and tests of articulation. Pitch measurement may be based on research from Vanderbilt University’ cognitive auditory research lab. One skilled in the art appreciates that there are many auditory testing, measuring, and analysis systems that are configured to assess development of language and/or early literacy acquisition skills of pre-school age children that may be used by the various embodiments of the phonation system 100.

Practitioners may define curriculum for using neurological music therapy strategies by controlling operation of embodiments of the phonation system 100. Such curriculum may be used to facilitate any known or later developed auditory testing, measuring, and analysis systems. Here, practitioners may select particular phonation system songs of interest, and then design fun and amusing phonation system games, that present such designated phonation system songs and the corresponding graphical animations 202 for children of interest. Once designed, the phonation system 100 may present the selected phonation system games and phonation system songs to facilitate growth of the child’s language and early literacy skills, and monitor over time performance changes in the child’s acquisition of those skills.

In alternative embodiments, other attributes of the pre-school age child, when singing the phonation system song during play of the phonation system game, may be acquired. For example, the image capture device 120 may capture still images or a video of the child as they are singing the phonation system song. Image data (still images, or individual images of the video stream) are time stamped. The presentation time of the phonation system song and the associated phonation system game may also be time stamped in a suitable manner so that the captured images and the song words may be time synchronized together. This image information may be saved into the user history database 136 for later analysis.

In an example embodiment, the score calculation module 142 calculates a score for each analyzed song word and/or a score for the phonation system song that the child has sung while playing the phonation system game. The computed score represents the accuracy of the child’s singing of the phonation system song. Scores may be determined for any audible characteristic of interest, such as timing, annunciation, and/or pitch. Or, an aggregate score may be computed that incorporates a plurality of audible characteristics.

In a non-limiting example embodiment, a point-based scoring system, or a percentage based scoring system, quantifies the accuracy of one or more of the determined attributes described herein. For example, if the scoring indicates 100% performance, or a performance within a predefined tolerance, then a determination is made that the child is correctly and accurately singing the phonation system song. Here, timing of song words, annunciation of song words, and/or pitch of song words may indicate acceptable performance. Calculated scores are saved into the user history database 136. The stored score information also includes a suitable time stamp (date and optionally time) corresponding to when the child sang the phonation system song.

Optionally, the score may be presented on the display 106 after the conclusion of the phonation system song, or at any time during presentation of the phonation system song. Here, an adult who is with the singing child will be able to view the presented score, and therefore intuitively appreciate the current state of the child’s performance. In some embodiments, graphical icons intuitively understandable by the child may be used to represent the score. For example, two cherries (graphical icons) may indicate a fist level of performance to the child, and more cherries may indicate a higher level of performance to the child. Any suitable incentivizing graphic that the child intuitively understands is associated with performance levels may be used by the various embodiments.

Additionally, the name or other suitable identifier of the child may be saved with the performance score information. Here, a particular electronic screen-based device 102 may be used at different time by different pre-school age children, such as at a pre-school facility. Curriculum intended for individual children may be associated with that child’s identifier. Test results stored in the user history database 136may be associated with the particular child’s identifier. The adult may specify the identifier of the child when operating the electronic screen-based device 102. Alternatively, or additionally, the face of the child may be identified by the speech, face and gesture recognition module 150 so that the identity of the child may be determined independent by the electronic screen-based device 102.

Assuming that the pre-school age child periodically plays the phonation system game, a database of the child’s performance scores may be acquired over time. Changes in performance scores over time may be used to indicate progress of the child in acquiring music, language and/or early literacy skills. Performance metrics may be determined to assess the child’s progress over some period of time. If the performance metrics indicate an unsatisfactory progression in acquisition of certain skills of interest, then a practitioner may develop a suitable speech and/or language intervention plan for the child based on the information acquired by the phonation system 100.

Optionally, a speech and/or language intervention plan may incorporate use of the phonation system 100. One or more phonation system games and/or phonation system songs configured to help develop identified speech and/or language deficiencies may be selected for presentation to the child during game play. Such deficiencies may be determined based on the specified objectives of the speech and/or language intervention plan. For example, if the child is having trouble annunciating “r” type words, then the game associated with the “Row, Row, Row Your Boat” song may be selected during game play by the child. As another example, if the child has auditory problems in hearing pitches, then phonation system songs emphasizing various targeted pitches may be selected for presentation to the child during game play.

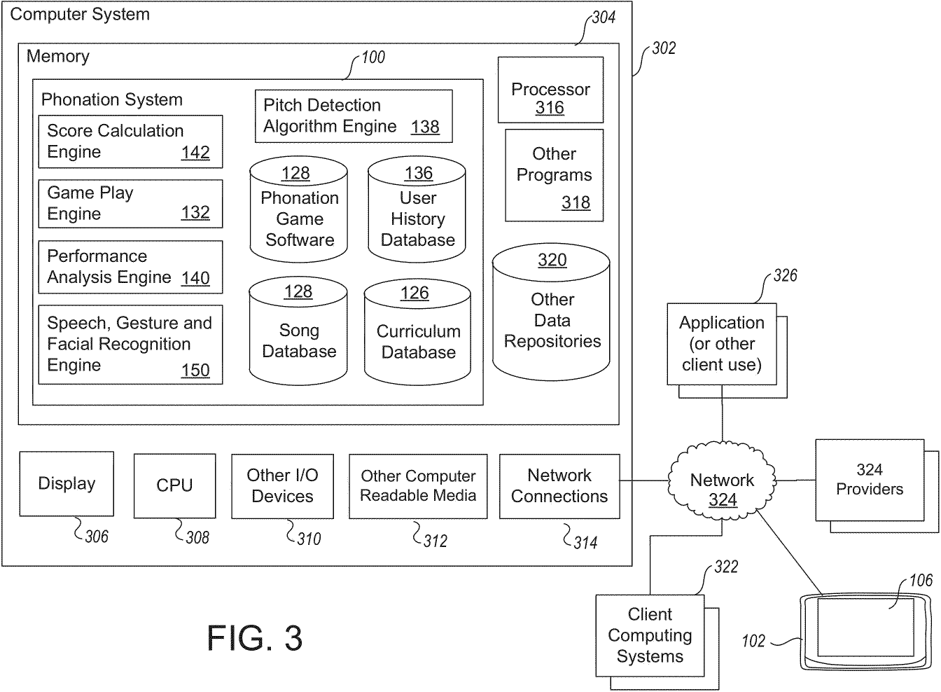

FIG. 3 is an example block diagram of a distributed computing system 302 that may be used to practice embodiments of a phonation system 100 described herein. Note that one or more general purpose virtual or physical computing systems suitably instructed or a special purpose computing system may be used to implement a phonation system 100. Further, the phonation system 100 may be implemented in software, hardware, firmware, or in some combination to achieve the capabilities described herein.

Note that one or more general purpose or special purpose computing systems/devices may be used to implement the described techniques. However, just because it is possible to implement the phonation system 100 on a general purpose computing system does not mean that the techniques themselves or the operations required to implement the techniques are conventional or well known.

The computing system 302 may comprise one or more server and/or client computing systems, and/or may span distributed locations. In addition, each block shown may represent one or more such blocks as appropriate to a specific embodiment or may be combined with other blocks. Moreover, the various blocks of the computer system 102 may physically reside on one or more machines, which use standard (e.g., TCP/IP) or proprietary interprocess communication mechanisms to communicate with each other.

In the embodiment shown, computer system 302 comprises a computer memory (“memory”) 304, an optional display 306, one or more Central Processing Units (“CPU”) 308, Input/Output (I/O) devices 310 (e.g., keyboard, mouse, CRT or LCD touch sensitive display, audio speakers, etc.), other computer-readable media 312, and one or more network connections 314. Selected components of the phonation system 100 are shown residing in memory 304 for purposes of disclosing the phonation system 100. In other embodiments, some portion of the contents, some of, or all of the components of the phonation system 100 may be stored on and/or transmitted over the other computer-readable media 312. The components of the phonation system 100 preferably execute on one or more CPUs 308, or processor 316 residing in memory 304, and manage the generation and use of the phonation system 100 as described herein. Other code or programs 318 and potentially other data repositories, such as data repository 320, may also optionally reside in the memory 304, and preferably execute on one or more CPUs 308. Of note, one or more of the components in FIG. 3 may not be present in any specific implementation. For example, some embodiments embedded in other software may not provide means for user input or display which are otherwise provided remotely by other electronic devices (client computing systems) 322.

In a typical embodiment, the phonation system 100 has implemented example the components locally. In at least some embodiments, one or more of these components may be provided external to the computing system 302 and may be available, potentially, over one or more networks 324. In addition, the phonation system 100 may interact via a network 324 with other applications 326 or client computing systems 322 that use results computed by the computer 302, one or more client computing systems 322, and/or one or more third-party information provider systems 328, such as purveyors of information used in the data repositories 320, databases 114, 116, 118, and/or game software 112. Also, of note, one or more of the data repositories 320, databases 114, 116, 118, and/or game software 112 may be provided external to the computer system 302 as well, for example in a WWW knowledge base accessible over one or more networks 324.

In an example embodiment, components/modules of the phonation system 100 are implemented using standard programming techniques. For example, the phonation system 100 may be implemented as a “native” executable running on the CPU 308, along with one or more static or dynamic libraries. In other embodiments, the phonation system 100 may be implemented as instructions processed by a virtual machine. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported. Also, other functions could be implemented and/or performed by each component/module, and in different orders, and in different components/modules, yet still achieve the described functions.

In addition, programming interfaces to the data stored as part of the phonation system 100 (e.g., in the data repositories 320, databases 114, 116, 118, and/or game software 112) can be available by standard mechanisms such as through C, C++, C#, and Java APIs; libraries for accessing files, databases, or other data repositories; through scripting languages such as XML; or through Web servers, FTP servers, or other types of servers providing access to stored data. The data repositories 112, 114, 116, and/or 118 may be implemented as one or more database systems, file systems, or any other technique for storing such information, or any combination of the above, including implementations using distributed computing techniques.

Also the example phonation system 100 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of the phonation system 100.

Furthermore, in some embodiments, some or all of the components of the phonation system 100 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

In some embodiments, the phonation system 100 executing on the computer system 302 is in real time communication with an electronic screen-based device 102, such as the smart phone or other user device, when a pre-school age child is interacting with the phonation system 100. Other forms of the electronic screen-based device 102 include, but are not limited to, personal computers, lap top computers, notebooks, virtual reality headsets, and other special purpose electronic devices that are used by the pre-school age child. In some embodiments, all or part of the phonation system 100 may be implemented on the remotely located electronic screen-based device 102. All such electronic screen-based devices 102 now known or later developed are intended to be within the scope of this disclosure and are intended to be protected by the claims of this disclosure.

In practice, a pre-school age child operates their electronic screen-based device 102 to play the phonation system game. The game play engine 132, executing the phonation game software 128, access a two dimensional (2D) or three dimensional (3D) character model to render and present graphical animation 202 that includes an animated avatar 204 (FIG. 2) representing at least one game character (depending upon whether the game is presenting in a 2D or 3D format) on a display 106 of the remote electronic screen-based device 102.

During game play, at some juncture, a specially configured phonation system song is retrieved from the song database 128 residing in the computer 302, and is communicated to the electronic screen-based device 102 for presentation to the pre-school age child. The generated graphical animation is also communicated to the electronic screen-based device 102 for presentation on the display 106. The child interacts with the presenting phonation system game using their electronic screen-based device 102 (or the computer system 302). Alternatively, or additionally, the pre-school age child may interact with the game play using another object, such as a musical instrument or the like.

During game play, the electronic screen-based device 102 captures audio data, and/or optionally captures video data, of the child user while the phonation system game is being played. This acquired video and/or audio information is communicated to the computer system 302 (or to the processor system of the electronic screen-based device 102) for analysis.

The student performance analysis engine 140 receives the captured image and/or audio data as an input from the electronic screen-based device 102 (or the other I/O devices 310 of the computing system 302) corresponding to the user’s game play. Optionally, the speech, gesture and facial recognition engine 150 receives input pertaining to the child user during game play.

In some embodiments, gestures made by the child user may be identified and analyzed, and then stored into the user history database 136. Additionally, facial recognition algorithms may be used to analyze the mouth and/or eye movement of the child user during game play, with the analysis results being also stored in the user history database 136. Other supplemental information, such as identity information, age, sex, address, parental information, past performance information, or the like associated with the child user may be stored in the user history database 136.

The stored user information may be later analyzed by a practitioner, such as a speech and language practitioner (SLP), to ascertain progress of the child user and/or to identify speech and language areas that that the child user may need further coaching on. In some embodiments, the phonation system 100 may be configured to automatically give feedback to the pre-school age child and/or a supervising adult on a real time basis during game play. Alternatively, or additionally, the presenting phonation system game may be modified in real time based on the acquired and analyzed user information. For example, phonation system songs may be selected.

In practice, the computer system 302 is communicatively coupled to the electronic screen-based device 102 being used by the pre-school age child. In a distributed embodiment, an application (APP) residing in the electronic screen-based device 102 is configured to establish communication connectivity to the computer system via the setwork connections 314, 116. Alternatively, the electronic screen-based device 102 may become communicatively coupled to the computer system 301 using a wireless communication system, via a wireless transceiver 118 residing in the electronic screen-based device 102.

Once the electronic screen-based device 102 is communicatively coupled to the computer system 302, a selected phonation system game with one or more phonation system songs may be communicated to the electronic screen-based device 102. The received phonation system game and the associated phonation system songs may be presented by the phonation system 100 APP implemented in the electronic screen-based device 102. Alternatively, the phonation system game may be executed at the computer system 302, wherein generated animations and phonation system songs are communicated to the electronic screen-based device 102 in real time.

It should be emphasized that the above-described embodiments of the phonation system 100 are merely possible examples of implementations of the invention. Many variations and modifications may be made to the above-described embodiments. All such modifications and variations are intended to be included herein within the scope of this disclosure and protected by the following claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. A method, comprising:
presenting a phonation system game to a child using an electronic screen-based device,
wherein the phonation system game presents a graphical animation on a display of the electronic screen-based device,
wherein a phonation system song is emitted from a speaker of the electronic screen-based device, and
wherein the graphical animation and the phonation system song are synchronously presented together by the electronic screen-based device,
detecting sounds in proximity to the electronic screen-based device using a sound detector;
outputting an audio data stream from the sound detector;
identifying a song word sung by the child from the output audio data stream;
identifying a song word presented by the phonation system song,
wherein the song word presented by the phonation system is the same as the song word sung by the child;
identifying, from the output audio data stream, an attribute of interest in the song word sung by the child;
retrieving a predefined song word attribute associated with the song word presented by the phonation system from a coded event database,
wherein the predefined song word attribute is associated with the song word sung by the child; and
comparing the predefined song word attribute with the identified attribute of interest in the song word sung by the child.

2. The method of claim 1,
wherein the comparison of the predefined song word attribute with the identified attribute of interest in the song word sung by the child corresponds to accuracy of the child’s ability to accurately annunciate the song word.

3. The method of claim 1, wherein the predefined song word attribute and the identified attribute of interest in the song word sung by the child is a pitch of the song word, the method further comprising:
determining, from the output audio data stream, a pitch of the song word sung by the child; and
comparing a predefined pitch of the song word presented by the phonation system with the determined pitch of the song word sung by the child.

4. The method of claim 3, wherein the pitch comparing further comprises:
determining whether the determined pitch of the song word sung by the child is the same as the predefined pitch of the song word presented by the phonation system; and
determine that the voice pitch of the child is correct in response to determining that the pitch of the song word sung by the child is the same as the predefined pitch of the song word presented by the phonation system.

5. The method of claim 4, wherein when the determined pitch of the song word sung by the child is not the same as the predefined pitch of the song word presented by the phonation system, the method further comprising:
determining a difference between the pitch of the song word sung by the child and the predefined pitch of the song word presented by the phonation system.

6. The method of claim 5, further comprising:
storing the determined a difference between the pitch of the song word sung by the child and the predefined pitch of the song word presented by the phonation system into a user history database residing in a memory medium.

7. The method of claim 5, further comprising:
determining a score based on the determined a difference between the pitch of the song word sung by the child and the predefined pitch of the song word presented by the phonation system into a user history database residing in a memory medium; and
presenting the score on the display of the electronic screen-based device.

8. The method of claim 1, wherein prior to presenting the phonation system game to the child, the method further comprises:
receiving specification of a curriculum,
wherein the curriculum is associated with an attribute of interest,
wherein the curriculum is associated with at least one of a plurality of phonation system games, and
wherein the associated plurality of phonation system games facilitate acquisition of the attribute of interest by the child; and
selecting the phonation system game that is associated with the curriculum from the plurality of phonation system games for presentation to the child.

9. The method of claim 1, wherein prior to presenting the phonation system game to the child, the method further comprises:
receiving specification of a curriculum,
wherein the curriculum is associated with an attribute of interest,
wherein the curriculum is associated with at least one of a plurality of phonation system songs, and
wherein the associated plurality of phonation system games facilitate acquisition of the attribute of interest by the child; and
selecting the phonation system song that is associated with the curriculum from the plurality of phonation system songs for presentation to the child.

10. The method of claim 1, wherein the predefined song word attribute and the identified attribute of interest in the song word sung by the child is an annunciation of the song word, the method further comprising:
determining an annunciation of the song word sung by the child; and
comparing a predefined annunciation of the song word presented by the phonation system with the determined annunciation of the song word sung by the child.

11. The method of claim 10, wherein the annunciation comparing further comprises:
determining whether the determined annunciation of the song word sung by the child is the same as the predefined annunciation of the song word presented by the phonation system; and
determine that the annunciation by the child is correct in response to determining that the annunciation of the song word sung by the child is the same as the predefined annunciation of the song word presented by the phonation system.

12. The method of claim 1, further comprising:
parsing the sounds detected in proximity to the electronic screen-based device into a first audio data stream corresponding to the song words sung by the child and into a second audio data stream corresponding to the song words presented in the phonation system song;
identifying the song word sung by the child from the first audio data stream; and
identifying the song word presented by the phonation system song from the second audio data stream.

13. The method of claim 1, wherein the predefined song word attribute and the identified attribute of interest in the song word sung by the child is a time of the song word in the phonation system song, the method further comprising:
determining a starting time of the song word sung by the child; and
comparing a predefined starting time of the song word presented by the phonation system with the determined starting time of the song word sung by the child.

14. The method of claim 13, further comprising:
determining an ending time of the song word sung by the child; and
comparing a predefined ending time of the song word presented by the phonation system with the determined ending time of the song word sung by the child.

15. The method of claim 14, further comprising:
determining that the timing by the child is correct in response to:
determining that the starting time of the song word sung by the child is the same as the predefined starting time of the song word presented by the phonation system, and
determining that the ending time of the song word sung by the child is the same as the predefined ending time of the song word presented by the phonation system.

16. The method of claim 15, further comprising:
determining a first difference between the starting time of the song word sung by the child with the predefined starting time of the song word;
determining a second difference between the ending time of the song word sung by the child with the predefined ending time of the song word; and
determining that the timing by the child is correct when:
the first difference is within a first predefined threshold, and
the second difference is within a second predefined threshold.

17. The method of claim 1, wherein identifying the song word presented by the phonation system song comprises:
identifying the song word presented by the phonation system song word from the output audio data stream.

18. The method of claim 1, wherein identifying the song word presented by the phonation system song comprises:
identifying the song word presented by the phonation system song word from a known location of the song word in the presentation system song.

19. The method of claim 1, wherein identifying the song word presented by the phonation system song comprises:
identifying the song word presented by the phonation system song word from a known time stamp associated with the song word in the presentation system song.
